(19) United States
(12) Patent Application Publication
(10) Pub. No.: US 2013/0255858 A1
(43) Pub. Date: Oct. 3, 2013

(54) METHOD OF MANUFACTURING A LAMINATE CIRCUIT BOARD

(71) Applicants: Jun-Chung Hsu, Taoyuan (TW); Chi-Ming Lin, Taipei (TW); Tso-Hung Yeh, New Taipei (TW); Ya-Hsiang Chen, Yunlin (TW)

(72) Inventors: Jun-Chung Hsu, Taoyuan (TW); Chi-Ming Lin, Taipei (TW); Tso-Hung Yeh, New Taipei (TW); Ya-Hsiang Chen, Yunlin (TW)

(21) Appl. No.: 13/437,933

(22) Filed: Apr. 3, 2012

(51) Int. Cl. B32B 38/10; B32B 38/08

(52) U.S. Cl. 156/150; 156/60; 156/247

(57) ABSTRACT

A method of manufacturing a laminate circuit board is disclosed. The method includes forming a metal layer on a substrate, patterning the metal layer to form a circuit metal layer, forming a nanometer plating layer with a thickness of 5 to 40 nm over the circuit metal layer, and forming a cover layer covering the substrate and the nanometer plating layer with improved adhesion by chemical bonding to form the laminate circuit board. Another method includes forming the circuit metal layer and the nanometer plating layer on a preforming substrate, pressing the preforming substrate against a substrate to push the circuit metal layer and the nanometer plating layer into the substrate, and removing the preforming substrate. By the present invention, the density of circuit is increased and much denser circuit can be implemented on the substrate with the same area.

### BACKGROUND OF THE INVENTION

1. Field of the Invention

The present invention generally relates to a method of manufacturing a laminate circuit board, and more specifically to forming a nanometer plating layer over a circuit metal layer.

2. The Prior Art

Please refer to FIG. 1. The traditional laminate circuit board 1 generally comprises a substrate 10, a circuit metal layer 22 and a cover layer 30, as shown in FIG. 1. The substrate 10 has a rough upper surface 15, and the circuit metal layer 22 is formed on the upper surface 15 of the substrate 10 and usually made of at least one of copper, aluminum, silver and gold. The cover layer 30 is a binder or a solder resist, which is used to electrically insulate and protect the circuit metal layer 22. However, the circuit metal layer 22 and cover layer 30 are made of different materials, so it usually needs to roughen the outer surface 25 of the circuit metal layer 22 through chemical, mechanical or plasma treatment so as to increase the surface friction coefficient and avoid peeling off. The junction property is thus improved by the rough outer surface 25.

However, one of the shortcomings of the circuit metal layer 22 with the roughened surface in the prior arts is that the design of the circuit on the metal layer is extremely constrained as the circuit becomes much denser because it is necessary to reserve some circuit width to compensate the loss due to the roughening process. Therefore, it needs a method of manufacturing the laminate circuit board without any reserved circuit width to increase the density of the circuit.

### SUMMARY OF THE INVENTION

A primary objective of the present invention is to provide a method of manufacturing a laminate circuit board, comprising the following steps: forming a metal layer on a substrate having a rough upper surface; patterning the metal layer to form a circuit metal layer by a pattern transfer process; forming a nanometer plating layer with a thickness of 5 to 40 nm over the circuit metal layer, said nanometer plating layer having a roughness which is defined by Ra (Arithmetical mean roughness) less than 0.35 μm and Rz (Ten-point mean roughness) less than 3 μm; and forming a cover layer by a binder or a solder resist covering the substrate and the nanometer plating layer so as to form the laminate circuit board. In this way, the circuit metal layer has three smooth sides. The outer surfaces of the circuit metal layer and the nanometer plating layer do not have a recognizable roughness by cross-sectional examination through an optical microscope of 1,000 magnifications.

Another objective of the present invention is to provide a method of manufacturing a laminate circuit board, comprising the steps of: forming a metal layer on a preforming substrate having a smooth surface with a roughness defined by Ra<0.35 μm and Rz<3 μm; patterning the metal layer to form a circuit metal layer through a pattern transfer process; forming a nanometer plating layer with a thickness of 5 to 40 nm over the circuit metal layer, said nanometer plating layer having a roughness which is defined by Ra less than 0.35 μm and Rz less than 3 μm; pressing the preforming substrate against a substrate to push the circuit metal layer and the nanometer plating layer into the substrate; and removing the preforming substrate to form the laminate circuit board. In this way, the circuit metal layer has four smooth sides. The smooth surface of the preforming substrate, and the outer surfaces of the nanometer plating layer and the circuit metal layer has an outer surface do not have a recognizable roughness by cross-sectional examination through an optical microscope of 1,000 magnifications.

The method of the present invention can improve the junction adhesion by the chemical bonding between the nanometer plating layer and the cover layer or the substrate. Furthermore, the roughening process used in the prior arts to increase the junction adhesion is also improved so as to eliminate the side effect resulting from the compensation for the scale because the whole surface of the laminate circuit board implemented by the method of the present invention is well smooth without the necessity of the compensation. Therefore, the density of the circuit can increase and much more dense circuit can be implemented in the substrate with the same area.

### BRIEF DESCRIPTION OF THE DRAWINGS

The present invention can be understood in more detail by reading the subsequent detailed description in conjunction with the examples and references made to the accompanying drawings, wherein:

FIG. 1 shows the schematic diagram to illustrate the traditional laminate circuit board;

FIG. 2 shows the flow chart to illustrate the method of manufacturing a laminate circuit board according to the first embodiment of the present invention;

FIGS. 3A to 3D show the cross-sectional diagrams to illustrate the method according to the first embodiment of the present invention;

FIG. 4 shows the flow chart to illustrate the method of manufacturing a laminate circuit board according to the second embodiment of the present invention; and

FIGS. 5A to 5E show the cross-sectional diagrams to illustrate the method according to the second embodiment of the present invention.

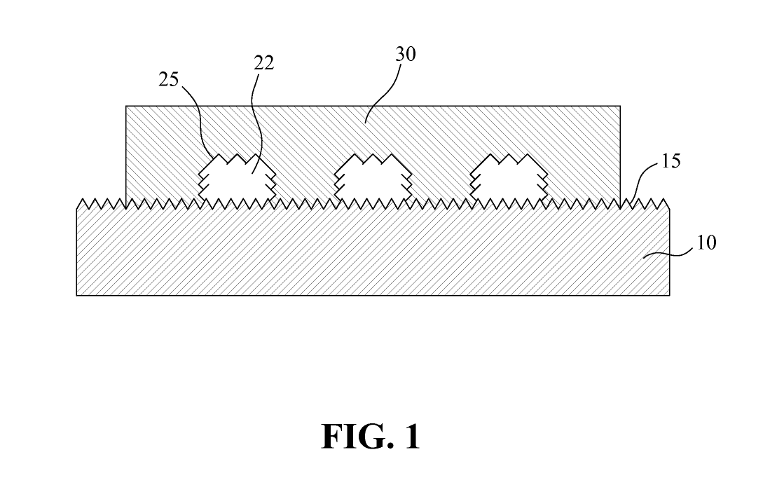

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

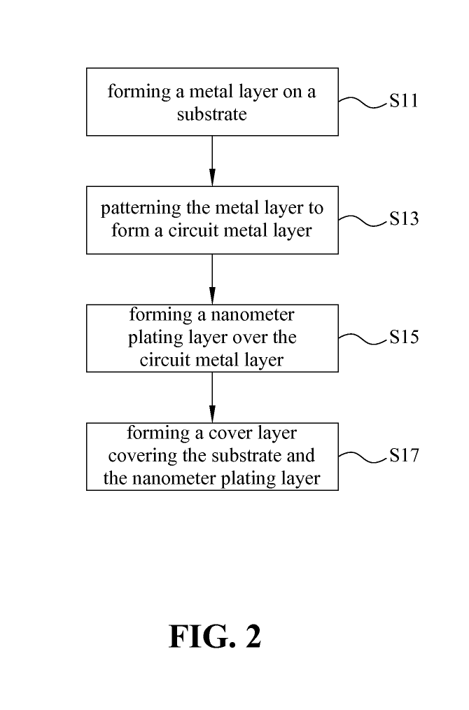

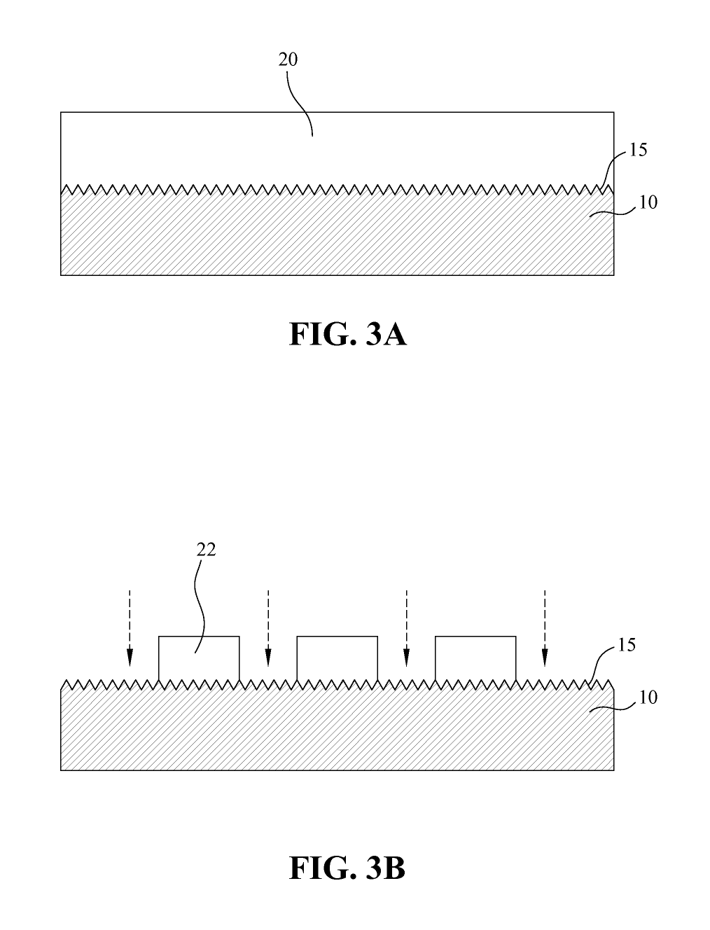

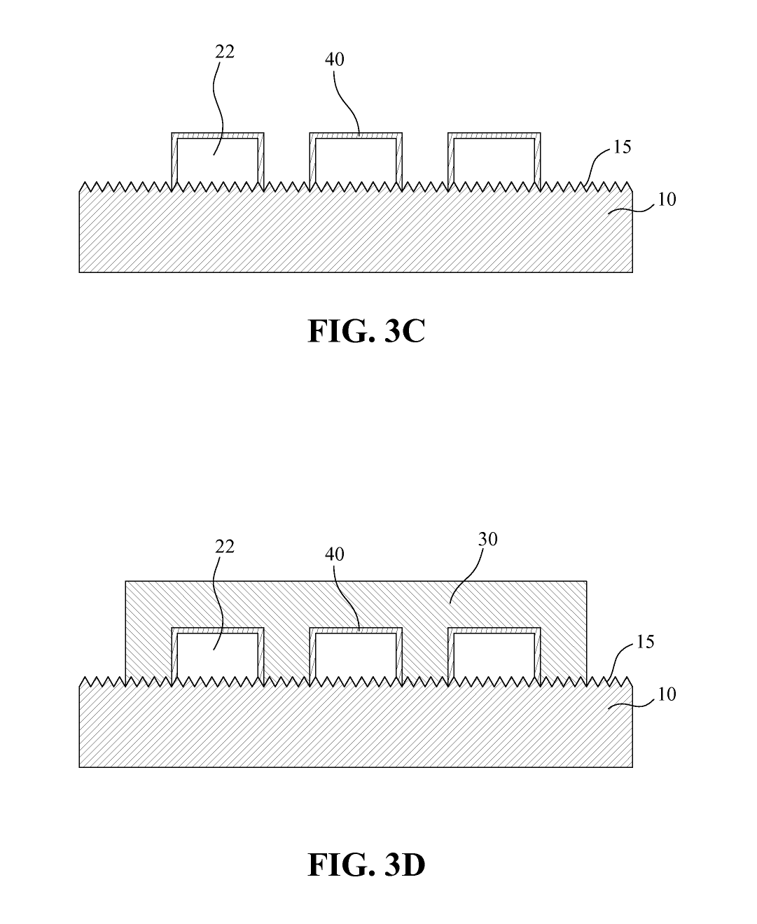

Please refer to FIG. 2. The method of manufacturing a laminate circuit board according to the first embodiment of the present invention comprises the sequential steps S11, S13, S15 and S17 to manufacture the laminate circuit board, which has, from bottom up, at least a substrate, a circuit metal layer, a nanometer plating layer and a cover layer. To explain the features of the present invention in more detail, please further refer to FIGS. 3A to 3D, showing the flow chart of the method in accordance with the first embodiment. As shown in FIG. 3A, the step S11 is to form a metal layer 20 on a substrate 10, which is made of FR4 glass fiber or bismaleimide triazime resin. The substrate 10 has a rough upper surface 15. The metal layer 20 is made of at least one of copper, aluminum, silver and gold.

In FIG. 3B, the step S13 is to pattern the metal layer 20 to form a circuit metal layer 22 by using lithography, wet etch or laser scribe, plasma treatment and the like. As shown in FIG. 3C, the step S15 is to form a nanometer plating layer 40 with a thickness of 5 to 40 nm over the outer surface of the circuit metal layer 22. The nanometer plating layer 40 has a roughness which is defined by Ra less than 0.35 μm and Rz less than 3 μm. Additionally, the nanometer plating layer 40 is made of at least two of copper, tin, aluminum, nickel, silver and gold. The step S15 can be implemented by electroless plating (i.e. chemical plating), evaporation, sputtering or atomic layer deposition (ALD). For example, the nanometer plating layer 40 is formed by the electroless plating, in which the circuit metal layer 22 is immersed in a chemical replacing solution to perform an atomic replacement reaction, and the chemical replacing solution comprises least one of alkylene glycol 30˜35 wt %, sulfuric acid 10˜30 wt %, thiourea 5˜10 wt %, and tin compound 5 wt %.

The step S17 shown in FIG. 3D is to form a cover layer 30 made of a binder or a solder resist, covering the circuit metal layer 22 and the nanometer plating layer 40. With the method of the first embodiment according to the present invention, the circuit metal layer 22 can form a structure with three smooth sides such that the outer surfaces of the circuit metal layer 22 and the nanometer plating layer 40 do not have a recognizable roughness by cross-sectional examination through an optical microscope of 1,000 magnifications.

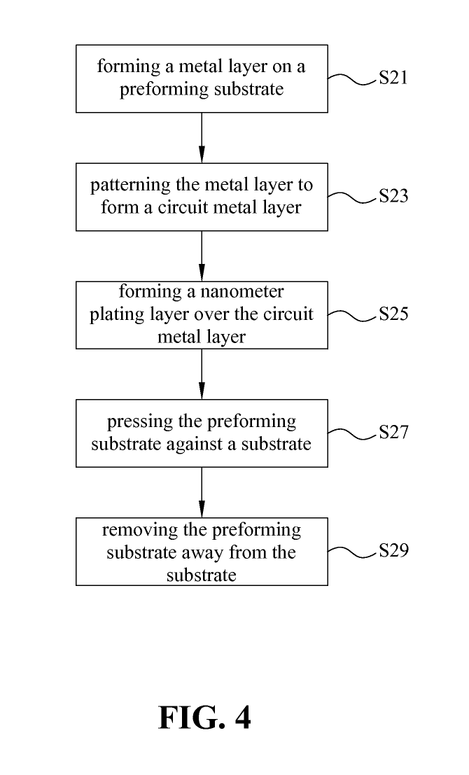

As shown in FIG. 4, the flow chart of the method of manufacturing a laminate circuit board according to the second embodiment of the present invention is illustrated to comprises the steps S21, S23, S25, S27 and S29, sequentially performed.

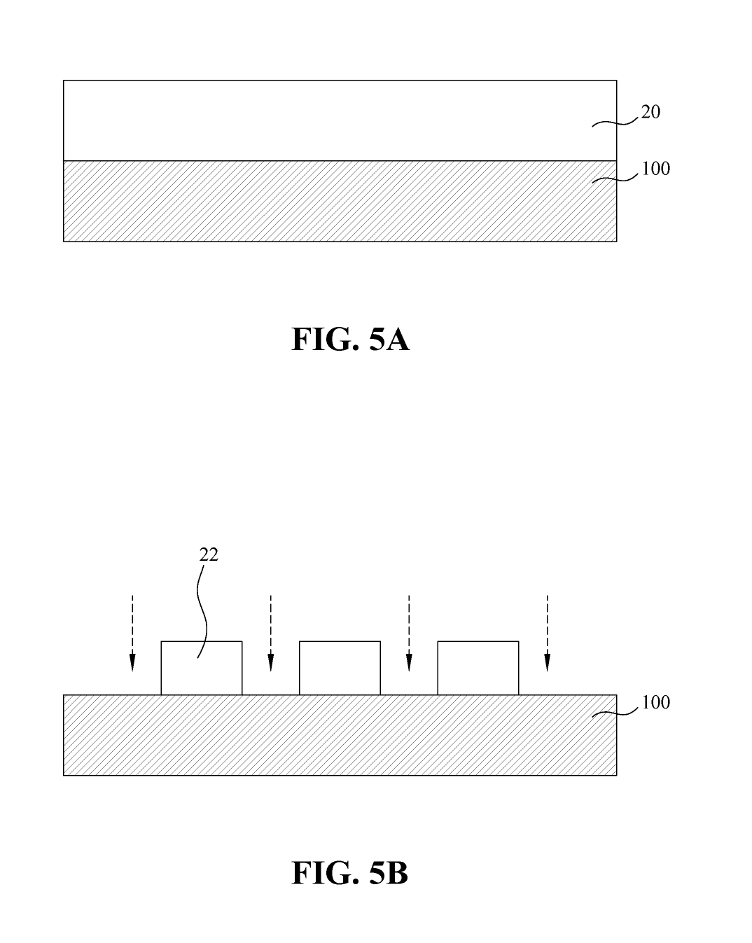

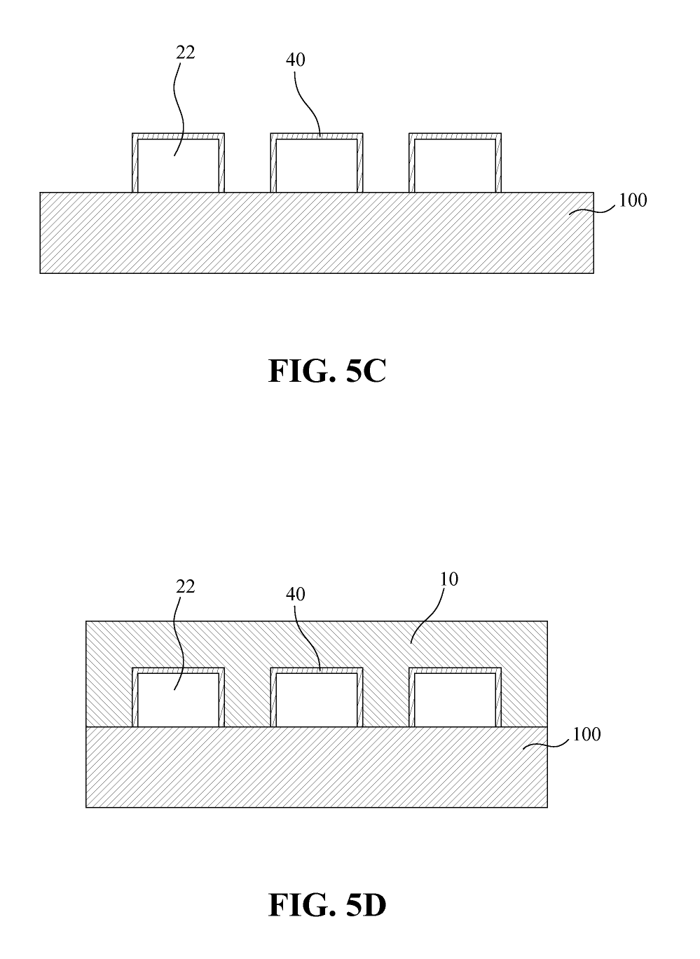

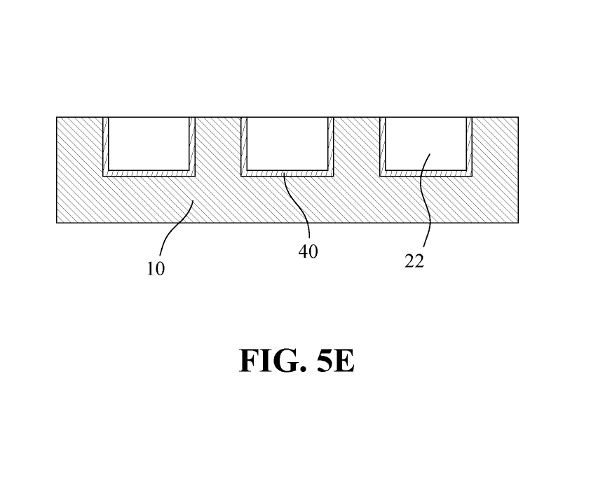

Please refer to FIGS. 5A to 5E for further explanation of the features of the second embodiment. In FIG. 5A, the step S21 is to form a metal layer 20 on a preforming substrate 100 having a smooth surface with an almost zero roughness, such as a roughness with Ra<0.35 μm and Rz<3 μm. The preforming substrate 100 can be made of a polish metal plate, such as a copper plate, an aluminum plate or a steel plate, or an insulation substrate covered with a polish metal film, such as an FR4 glass fiber plate covered with a polish copper film or a BT substrate covered with a polish aluminum film. It should be noted that the above example is only exemplarily illustrative, not limitative. As shown in FIG. 5B, the step S23 is to pattern the metal layer 20 to form the circuit metal layer 22 through lithography, wet etch or laser scribe, plasma treatment and the like.

In FIG. 5C, the step S25 is to form a nanometer plating layer 40 over the outer surface of the circuit metal layer 22, similar to the above-mentioned step 15. As shown in FIG. 5D, the step S27 is to press the preforming substrate 100 against a substrate 10 to push the circuit metal layer 22 and the nanometer plating layer 40 into the substrate 10. The smooth surface of the preforming substrate 100, and the outer surfaces of the circuit metal layer 22 and the nanometer plating layer 40 do not have a recognizable roughness by cross-sectional examination through an optical microscope of 1,000 magnifications.

As shown in FIG. 5E, the step S29 is to remove the preforming substrate 100 away from the substrate 10 to form the laminate circuit board such that the circuit metal layer 22 and the nanometer plating layer 40 are embedded in the substrate 10 and the circuit metal layer 22 forms a structure with four smooth sides.

The method of the present invention can improve the junction adhesion through the chemical bonding between the nanometer plating layer 40 and the cover layer 30 or the substrate 10. Also, the method of the present invention further eliminates the side effect which is caused by some reserved circuit width used to compensate the scale loss during the process of roughening the surface of the circuit metal layer 22 to improve the junction adhesion in the prior arts. This is because the laminate circuit board manufactured by the method according to the present invention forms a smooth and neat surface such that no reserved circuit width is needed to compensate the scale. Thus, the density of circuit is greatly increased for the same area.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of manufacturing a laminate circuit board, comprising steps of:
forming a metal layer on a substrate having a rough upper surface;
patterning the metal layer to form a circuit metal layer through a pattern transfer process;
forming a nanometer plating layer with a thickness of 5 to 40 nm over the circuit metal layer, said nanometer plating layer having a roughness which is defined by Ra (Arithmetical mean roughness) less than 0.35 μm and Rz (Ten-point mean roughness) less than 3 μm; and
forming a cover layer by a binder or a solder resist covering the substrate and the nanometer plating layer with adhesion by chemical bonding so as to form the laminate circuit board,
wherein each of said nanometer plating layer and said circuit metal layer has an outer surface, which does not have a recognizable roughness by cross-sectional examination through an optical microscope of 1,000 magnifications.

2. The method as claimed in claim 1, wherein said substrate is made of FR4 glass fiber or bismaleimide triazime resin, said metal layer is made of at least one of copper, aluminum, silver and gold, and said nanometer plating layer is made of at least two of copper, tin, aluminum, nickel, silver and gold.

3. The method as claimed in claim 1, wherein said nanometer plating layer is formed by electroless plating, evaporation, sputtering or atomic layer deposition.

4. The method as claimed in claim 3, wherein said nanometer plating layer formed by electroless plating is through a process of immersing said circuit metal layer in a chemical replacing solution to perform an atomic replacement reaction, and said chemical replacing solution comprises least one of alkylene glycol 30˜35 wt %, sulfuric acid 10˜30 wt %, thiourea 5˜10 wt %, and tin compound 5 wt %.

5. A method of manufacturing a laminate circuit board, comprising steps of:
forming a metal layer on a preforming substrate having a smooth surface with a roughness defined by Ra<0.35 μm and Rz<3 μm;
patterning the metal layer to form a circuit metal layer through a pattern transfer process;
forming a nanometer plating layer with a thickness of 5 to 40 nm over the circuit metal layer, said nanometer plating layer having a roughness which is defined by Ra less than 0.35 μm and Rz less than 3 μm;
pressing the preforming substrate against a substrate to push the circuit metal layer and the nanometer plating layer into the substrate; and
removing the preforming substrate away from the substrate to form the laminate circuit board,
wherein the smooth surface of the preforming substrate, and outer surfaces of said nanometer plating layer and said circuit metal layer do not have a recognizable roughness by cross-sectional examination through an optical microscope of 1,000 magnifications.

6. The method as claimed in claim 5, wherein said preforming substrate is a polish metal plate or an insulation substrate covered with a polish metal film, aid metal plate is made of a copper plate, aluminum plate or steel plate, and said insulation substrate is made of FR4 glass fiber or bismaleimide triazime resin.

7. The method as claimed in claim 5, wherein said nanometer plating layer is formed by electroless plating, evaporation, sputtering or atomic layer deposition.

8. The method as claimed in claim 7, wherein said nanometer plating layer formed by electroless plating is through a process of immersing said circuit metal layer in a chemical replacing solution to perform an atomic replacement reaction, and said chemical replacing solution comprises least one of alkyleneglycol 30˜35 wt %, sulfuric acid 10˜30 wt %, thiourea 5˜10 wt %, and tin compound 5 wt %.

9. The method as claimed in claim 5, wherein said substrate is made of FR4 glass fiber or bismaleimide triazime resin, said metal layer is made of at least one of copper, aluminum, silver and gold, and said nanometer plating layer is made of at least two of copper, tin, aluminum, nickel, silver and gold.
